(19) United States
(12) Patent Application Publication
(10) Pub. No.: US 2013/0004881 A1
(43) Pub. Date: Jan. 3, 2013

(54) COMPOSITE COATINGS FOR OXIDATION PROTECTION

(76) Inventors: Nima Shaigan, Vancouver (CA); Wei Qu, Vancouver (CA)

(21) Appl. No.: 13/583,111

(22) PCT Filed: Mar. 15, 2011
(86) PCT No.: PCT/CA2011/000269

§ 371 Date: Sep. 6, 2012

Related U.S. Application Data
(60) Provisional application No. 61/282,669, filed on Mar. 15, 2010.

(51) Int. Cl. C25D 11/38; H01M 2/22; B32B 15/04

(52) U.S. Cl. 429/465; 205/50; 205/109

(57) ABSTRACT

The invention disclosed relates to an oxidized metal matrix composite coated substrate, comprising a substrate made of a material selected from the group consisting of a chromia-forming Fe, Ni and/or Co based alloy containing an amount of Cr ranging from 16 to 30 wt %, and an oxide-dispersion strengthened Cr-based alloy and a plain Cr-based alloy, and an oxidized metal matrix composite coating comprising at least two metals and reactive element oxide particles in the form of a tri-layer scale on the substrate surface comprising an inner chromia layer, an intermediate layer of a spinel solid solution formed by Cr and one or more of the deposited metals selected from the group consisting of Ni, Co, Cu, Mn, Fe and Zn and a mixture thereof, and an electrically conductive top layer comprising oxides of one or more deposited metals selected from the group consisting of Ni, Co, Cu, Fe, Mn, Zn and a mixture thereof, which is substantially free from Cr ions, and wherein one or more of such layers contain particles of doped or undoped oxides of a rare earth metal selected from the group consisting of Ce, Y, La, Hf, Zr, Gd and a mixture thereof.

### BACKGROUND OF THE INVENTION

The invention disclosed relates to composite oxide coatings, and hi particular to an oxidized metal-matrix composite coated substrate and a method of coating therefore, wherein the coated substrate may be used as an electrical interconnect device for use at high temperature for oxidation protection, and specifically in solid oxide fuel cells (SOFC).

Several different types of fuel cells are under development, including the solid oxide fuel cell (SOFC). Solid oxide fuel cells typically operate at temperatures in the range of 600-1000° C. The individual cells are electrically connected in series to one another by a device known as an electrical interconnect, to form a multi-cell stack unit producing acceptable voltage. The interconnect material must be physically and chemically stable and electronically conductive under high-temperature oxidizing operating conditions of the fuel cell.

Recently, chromia forming alloys have been considered as the most appropriate materials for use in interconnects, due to the acceptable high-temperature conductivity of their protective chromia scale. However, chromia is not stable at the SOFC operating temperatures and evaporates as Cr(VI) species. Instability of chromia deteriorates its protective properties and evaporation of Cr poisons the cathode material. Therefore, use of chromia forming alloys results in cell degradation. Therefore, an effective coating is required to overcome these issues.

The chromia forming alloys that can be used as interconnect materials include stainless steels, superalloys (Fe, Ni or Co-based) or Cr-based alloys, an effective conductive/protective coating, however, is necessary to avoid evaporation of chromia and reduce the oxidation growth rate and cell degradation.

For stainless steels, Cr-based alloys and superalloys, numerous coatings have been considered as potential remedies in order to overcome the issues originating from the poor high-temperature oxidation and oxide scale properties. Various materials have been used in an effort to decrease oxide growth kinetics, increase oxide scale conductivity, improve oxide scale-to-metal adhesion and inhibit Cr migration from the chromia-rich subscales to the oxide surface. The materials used as coatings include reactive element oxides (REOs), conductive perovskites, MACrYO (where M represents a metal, e.g., Co, Mn and/or Ti) oxidation resistant alloys, conductive spinels [1] and conductive, composite spinels [2,3]. The techniques used for coating of the mentioned materials on stainless steels include sol-gel techniques, chemical vapour deposition (CVD), pulsed laser deposition, plasma spraying, screen printing and slurry coating, radio frequency (rt) magnetron sputtering, large area filtered are deposition and electrodeposition [2-6]. Among various materials, conductive spinels are the most appropriate and widely used materials W. These coating techniques are costly to apply and most of them depend on line-of-sight and are not suitable for coating complex interconnect shapes. However, the only process that is low-cost and can be used to uniformly coat complex shapes is electroplating/oxidation.

Although coatings with REOs reduce the oxidation growth rate and improve the oxide scale-to-metal adhesion, these coatings are not effective barriers against Cr outward migration. Coatings with rare earth perovskites (e.g., LaMnO₃) are brittle and susceptible to cracking and spallation upon thermal shocks. Also, perovskites are mixed ionic-electronic conductors and cannot inhibit oxygen inward transport and Cr outward migration. In addition, the main application technique for this type of coating is plasma spraying which is costly and produces thick and porous coatings, and deposition is highly dependent of line-of-sight which does not allow coating the complex shapes. Coatings with conductive spinels (e.g., (Co,Mn)₃O₄) can slow down the Cr outward diffusion and improve electrical conductivity of the interconnects [7,8] Spinel coatings can be deposited using screen printing, spraying, dip-coating, cathodic deposition followed by oxidation in air or anodic deposition of oxides followed by heat treatment to achieve spinel structure. Among the methods for application of spinel coatings, cathodic deposition of metals/alloys followed by annealing in air produces uniform, adherent coatings [4,5]. In addition, uniform coating of substrates with complex shapes is practical. However, interdiffusion between the metallic coating and the substrate during oxidation results in dilution of the alloy surface region in Cr which, in turn, leads to breakaway oxidation [2], Breakaway oxidation is the result of depletion of Cr in alloy and formation of a thick, impure and non-protective chromia layer which is susceptible to local damage. As a result, elements from the alloy start to oxidize and form oxide nodules on the surface and eventually lead to oxidation of the entire metal. Furthermore, spinels are not considered as protective oxides and cannot reduce the oxidation growth rate

Furthermore, all the above-mentioned coating techniques for alloys have been applied to overcome the oxidation related issues for temperatures in the range of 650-900° C. These coatings are not effective at temperatures higher than 900° C., and their application has not been reported in the literature.

Further, in U.S. Pat. No. 5,942,349 [9], a bi-layer protective coating for a Cr-containing interconnect device is provided. The coating on the cathode-side comprises an oxide surface layer comprising at least one metal(M) selected from the group consisting of Mn, Fe, Co and Ni, and an M-metal/Cr spinel layer between the interconnect/substrate and the oxide surface layer. The spinel layer is formed by reaction of the M-metal oxide with chromium oxide formed at the substrate surface and resists the evaporation of CFO, from the cathode-side surface of the interconnect. This coating may be applied by metal electrodeposition and oxidation. However, such coatings will not significantly reduce the oxidation rate as spinel and M metal oxide layers are not protective.

### SUMMARY OF THE INVENTION

Composite electrodeposited coatings are provided which enable the practical use of chromia forming alloys as solid oxide fuel cell interconnect substrate materials at elevated temperatures up to 1000° C. for long periods of time depending on the substrate type. Usually at temperatures above 950° C., only ceramic materials can be used as interconnects.

One of the key advantages of the present invention over U.S. Pat. No. 5,942,349 is the presence of rare earth metal oxide particles in one or more of the layers of the three layer oxide coating composite matrix. Such dispersed particles act a source of rare earth ions that are essential for reduction of oxidation rate and adhesion of the oxide coating.

According to the present invention, a chromia forming alloy with adequate Cr concentration between 16 and 30 wt %, preferably between 20-28 wt % is provided as the interconnect substrate. Alternatively, oxide dispersion strengthened (ODS) or plain Cr-based alloys can be used as the interconnect substrate. However, such alloys suffer from poor oxidation behaviour, oxide scale spallation and more importantly Cr evaporation from the oxide scale.

Accordingly chromia forming alloys including but not limited to stainless steels such as AISI 430C series, Crofer® 22 APU, Crofer® 22H, ZMG232 and ZMG232L Ni superalloys such as Haynes® 230® (with 22 wt % Cr), Co superalloys such as Haynes® 188® (with 22 wt % Cr) or Cr-based alloys such as Ducralloy, are preferred as the interconnect substrate.

A composite metal matrix coating is electrodeposited on the interconnect substrate. Oxidation of such metal matrix composite forms a unique three-layer oxide scale which decreases the contact resistance, substantially increases oxidation resistance, eliminates the oxide scale spallation and reduces Cr release.

The preferred method of coating is composite electrodeposition in an electrodeposition cell from an aqueous electrolyte comprising metal ions, optionally a buffering agent, optionally a complexing agent, rare earth metal oxide particles and optionally additives (e.g., surfactants). The anode comprises the metals to be deposited, or a permanent anode such as platinised titanium.

The reactive rare earth metal oxide particles are suspended in the electrolyte, containing the depositing metal ions, by means of mechanical stirring. The anode and cathode are placed horizontally in an electrodeposition cell plating bath. Application of direct or pulsating current results in deposition of metals on the cathode/interconnect substrate. Particles are adsorbed on the surface of the cathode substrate by electrostatic and gravitational forces, and the growth of the metallic coating layer encapsulates the particles and embeds them in the coating layer. Alternatively, sequential deposition of metals (and particles) from different electrolytes is also contemplated.

Oxidation of the coated substrate in air at 500-1000° C. results in formation of a three-layer oxide scale containing rare earth metal oxide particles. An inner chromia layer forms in the vicinity of the cathode substrate surface. An intermediate oxide layer forms by reaction of chromia and oxides of deposited metal(s) and is in the form of a spinel solid solution containing Cr ions, the deposited metal(s) ions and to a smaller extent elements diffused from the substrate alloy (e.g., Mn). The top layer comprises an electronically conductive solid solution of the oxides of the deposited metals and is substantially free of Cr ions. All of these layers may contain rare earth metal oxide particles that are essential to reduce the oxide growth rate and improve interfacial adhesion of the layers to one another and to the substrate. The intermediate spinel layer stabilizes the Cr and reduces its evaporation. The top oxide layer further acts as barrier against Cr outward diffusion and prevents a contact between the cathode material and the Cr containing spinel (intermediate layer). Such an oxide structure substantially reduces the oxidation rate, eliminates the oxide scale spallation, stabilizes Cr and provides a good electronic conductivity.

Such a coated substrate is particularly useful as an interconnect on the cathode side of the cells in a fuel cell (e.g SOFC) stack, but can be used on the anode side as well.

The primary application is in a SOFC. Other applications include gas turbine engine combustors, nuclear reactor components, resistance heating and other applications requiring the use of chromia forming alloys at elevated temperatures in an oxidizing environment.

According to one aspect of the invention, we provide an oxidized metal matrix composite coated substrate e.g. in the form of an electrical interconnect device, comprising a substrate made of a material selected from the group consisting of a chromia-forming alloy containing a sufficient amount of Cr ranging from 16 to 30 wt % preferably from 20 to 28 wt %, and an oxide-dispersion strengthened Cr-based alloy and a plain Cr-based alloy, and an oxidized metal matrix composite coating in the form of a tri-layer scale on the substrate surface comprising an inner chromia layer, an intermediate layer of a spinel solid solution formed by Cr and one or more of the deposited metal(M) selected from the group consisting of Ni, Co, Cu, Fe, Mn and Zn and a mixture thereof e.g. CoCr₂O₄, and to a some extent elements diffused from the substrate e.g. Mn and Fe if the substrate contains any, and an electrically conductive top layer comprising a solid solution of oxides of the deposited metals which is substantially free from Cr ions, wherein one or more of such layers contains particles of doped or undoped oxides of a rare earth metal selected from the group consisting of Ce, La, Y, Zr, Hf, Gd and a mixture thereof.

The particle size of the rare earth metal oxides can vary from 0.05-50 μm, preferably 0.5-3 μm and more preferably 0.5-1 μm.

In one embodiment of this aspect of the invention, the chromia-forming alloy is selected from the group consisting of chromia-forming stainless steels and Fe, Ni or Co-based alloys.

In an embodiment of this aspect of the invention, the electrical interconnect device is included in a solid oxide fuel cell (SOFC) stack, wherein the cathode side of the cell is in physical and electrical contact with the coated side of the interconnect device.

In another aspect of the invention, we provide a method of making an oxidized metal matrix composite coated substrate e.g. an electrical interconnect device, comprising
(a) providing an electrodeposition cell, including an anode, a chromia-forming cathode substrate and an aqueous electrolyte, wherein the said electrolyte comprises a source of a depositing metal (M) selected from the group consisting of Ni, Co, Mn, Cu, Fe, Zn and a mixture thereof, e, g, in the form of metal salts, such as sulfates and/or chlorides or complexed metal ions, e.g., Ni sulfamates; optionally a buffering compound, e.g., boric acid, optionally additives, e.g., surfactants, brighteners, and levelers and suspended insoluble particles of a doped or undoped oxide of a rare earth metal, selected from the group consisting of Ce, La, Y, H f, Zr, Gd and a mixture thereof. The particle size of the rare earth metal oxides can vary from 0.05 to 50 μm, preferably 0.5-3 μm and more preferably 0.5-1 μm. Alternatively, sequential deposition of metals (and particles) from different electrolytes is to be used when alloy deposition from a single electrolyte is not practical.
(b) pretreating the chromia-forming substrate to remove the native chromium oxide layer from the substrate surface, e.g. by the electrochemical or/and chemical etching of the substrate, the said chemical etching can be conducted in an aqueous solution of compounds selected from hydrochloric acid, nitric acid/hydrofluoric acid, ferric chloride or ceric ammonium nitrate,
(c) pretreating of the substrate, substantially free from oxide, by applying a thin (˜1 μm) strike Ni or Co plating to the substrate to prevent reformation of the oxide, wherein the plating can be conducted e.g. in an aqueous electrolyte containing Ni or Co chloride and hydrochloric acid using Ni or Co anodes.
(d) electrodepositing of a composite coating onto the pretreated (Ni- or Co-coated) chromia-forming substrate in the electrodeposition cell, wherein the cathode is the pretreated chromia-forming substrate, and wherein electrodepositing of the composite coating onto the substrate is performed by applying a direct or pulsating current to the electrodeposition cell, and
(e) oxidation in air of the coated substrate at elevated temperature e.g. temperatures in the range of 500 to 1000° C. for at least 24 hours, to form a unique composite tri-layer scale coating, comprising on the substrate surface an inner chromia layer, an intermediate spinel solid solution layer formed by Cr and one or more of the deposited metals(M) selected from the group consisting of Mn, Fe, Ni, Co, Cu and Zn, and a mixture thereof and to some extent elements diffused from the substrate e.g. Mn if the substrate contains any, and a top layer comprising an electrically conductive oxide layer of one or more of the deposited metal (M) selected from the group consisting of Ni, Co, Mn, Cu, Fe and Zn, which is substantially free of Cr ions, wherein one or more of such layers contains particles of a doped or undoped oxide of a rare earth metal selected from the group consisting of Ce, Y, La, Hf, Zr, Gd and a mixture thereof.

It is noted that Ni-plating is an essential (second) step of the substrate pretreatment and essential stage of the fabrication method. However, in the course of the final stage of the interconnect fabrication, namely at the high temperature oxidation, the Ni-layer is dissolved and diffuses into the substrate and coating. Accordingly, that is why there is no distinct Ni-layer in the structure of the final coated substrate.

In an embodiment of this aspect of the invention, the coated substrate is an electrical interconnect device, included in a solid oxide fuel cell (SOFC) stack, wherein the cathode side of the cell faces the coated side of the interconnect device, and the cathode is in physical and electrical contact with the coating.

In an embodiment of this aspect of the invention, the three-layer oxidized metal matrix composite coating contains rare earth metal oxides in all three layers.

### BRIEF DESCRIPTION OF THE DRAWING

FIG. 1 is a schematic representation of (a) as deposited coating and (b) oxidized coating on Haynes® 230®.

FIG. 2 is a schematic representation of the experimental set-up for Area Specific Resistance (ASR) measurements.

FIG. 3 is a Scanning Electron Microscopy (SEM) cross sectional image of the as-deposited Ni—Co/GDC Coating (50% Co) on Haynes®230®.

FIG. 4 are SEM cross sectional images of coated Haynes® 230° oxidized for (a) 170, (b) 500 and (c) 1000 hours at 1000° C.

FIG. 5 is a SEM image and corresponding Cr, Co and Ni Energy Dispersive X-ray (EDX) spectrometry elemental maps of coated Haynes® 230 oxidized for 1000 hours at 1000° C.

FIG. 6 is a glancing angle XRD pattern for coated Haynes® 230® oxidized for 1000 hours at 1000° C. The incident beam angle was 10°.

FIG. 7 are SEM plan view images of coated Haynes® 230® oxidized for (a) 170, (b) 500 and (c) 1000 hours at 1000° C.

FIG. 8 are SEM cross sectional images of uncoated Haynes® 230® oxidized for (a) 170, (b) 500 and (c) 1000 hours at 1000° C.

FIG. 9 are SEM image and corresponding Cr, Ni and W EDX elemental maps of uncoated Haynes® 230® oxidized for 1000 hours at 1000° C.

FIG. 10 is a Glancing angle XRD pattern for uncoated Haynes® 230° oxidized for 1000 hours at 1000° C.

FIG. 11 are SEM plan view images of uncoated Haynes® 230® oxidized for (a) 170, (b) 500 and (c) 1000 hours at 1000° C.

FIG. 12 is a graph showing the oxidation weight gain profiles as a function of time for coated and uncoated Haynes® 230® at 1000° C.

FIG. 13 is a graph showing the area specific resistance (ASR) as a function of time for coated and uncoated Haynes® 230® in air at 1000° C.

FIG. 14 are EDX Cr profiles across (a) coated and (b) uncoated Haynes® 230® screen printed with LSM and oxidized for 170 hours in air at 1000° C.

FIG. 15 is a graph showing oxidation weight gain as a function of time for Ni—Co (50% Co with no particles) coated, Ni—Co/GDC (50% Co) coated and uncoated ZMG232L® stainless steel at 750 and 1000° C.

FIG. 16 is a graph showing ASR for pre-oxidized (800° C., 48 h) Ni—Co/GDC coated ZMG232L® at different temperatures.

### DETAILED DESCRIPTION OF THE INVENTION

### Example 1

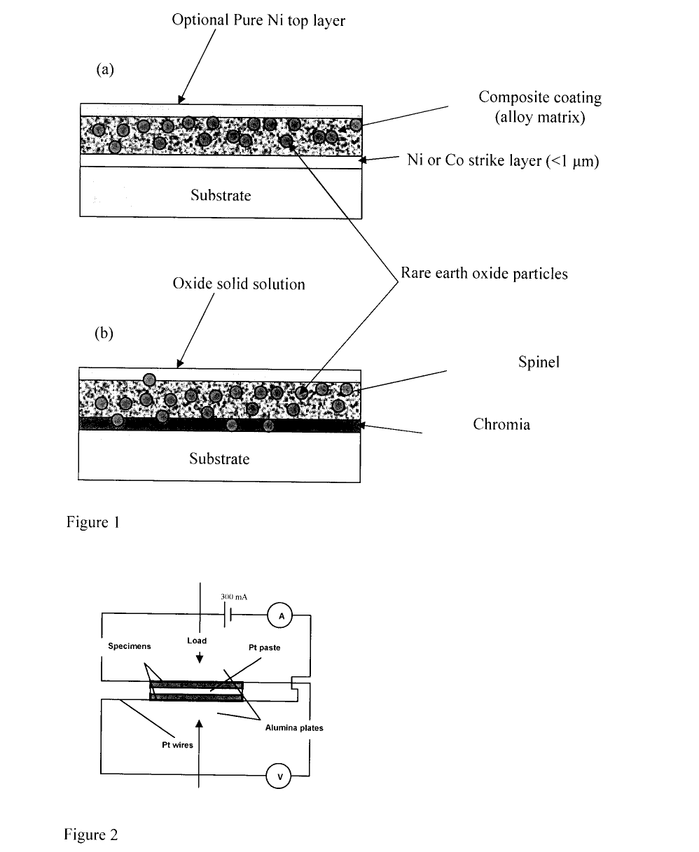

FIG. 1 represents a schematic drawing of as deposited coating (FIG. 1a) and of oxidized coating (FIG. 1b) with corresponding different layers. Haynes® 230®, Ni-based superalloy the composition of which is listed in Table I, was selected as the cathode substrate. The coating comprises Ni and Co alloy (50% Co) and gadolinia doped ceria, (CeO₂)_{0.9}—(Gd₂O₃)_{0.3}(GDC) particles (d₁₀=0.4 μm, d₅₀=0.5 μm, d₉₅=1 μm). Electroplating was used for deposition of the composite coating. The planar anode and cathode substrate were placed horizontally in the plating bath. The composition and operating conditions of bath used for composite electrodeposition are listed in Table II.

TABLE I
describes the nominal compositions of Haynes ® 230 ® (wt %)

| Ni | Cr | W | Mo | Fe | Co | Mn | Si | Al | C | La | B |
|---|---|---|---|---|---|---|---|---|---|---|---|
| 57 | 22 | 14 | 2 | 3 | 5 | 0.5 | 0.4 | 0.3 | 0.1 | 0.02 | 0.015 |

The cathode substrate is formed from a 2 mm thick Haynes® 230® sheet, cut into 20×20 mm coupons. The coupons were ground by grit 600 abrasive paper and cleaned ultrasonically in an alkaline cleaning solution containing 5 g/L NaOH, 5 g/L Na₃PO₄ and 0.1 g/L sodium dodecyl sulphate (SDS) for 2 minutes at 50-60° C. to remove contaminants from the surface. After alkaline cleaning, the samples were etched in 50% HCl at 50° C. for 2 minutes to remove metallic residues and native oxides. Anodic activation, followed by cathodic strike Ni plating, was performed according to ASTM B254-92 (2004) Practice 7.6.1 (Table III), in order to remove and prevent the reformation of the chromium oxide surface passive layer which inhibits electrodeposition on the cathode substrate Rinsing with deionized water was performed in between each process step.

TABLE II
Composition and operating conditions for Ni—Co/GDC
composite electroplating bath

| Nickel sulfate, hexahydrate (NiSO4•6H2O) | 250 | g/L |
|---|---|---|
| Nickel chloride, hexahydrate (NiCl2•6H2O) | 44 | g/L |
| Boric acid (H3BO4) | 40 | g/L |
| Cobalt sulfate, heptahydrate | 10 | g/L |
| (CoSO4•7H2O) | | |
| Coumarin (C9H6O2) | 0.3 | g/L |
| Sodium dodecyl sulfate (SDS) | 0.25 | g/L |
| (NaCl2H25SO4) | | |
| Gadolinia doped ceria, (CeO2)0.9-(Gd2O3)0.1 | 40 | g/L |

| | |
|---|---|
| Temperature | 50 ± 2° C. |
| pH | ~4, (adjusted with NaOH |
| | and/or H2SO4) |
| Agitation | Impeller from top |
| Current Density | 40 mA/cm2, DC |
| Anode | Ni and Co |

TABLE III

| | | |
|---|---|---|
| Nickel chloride hexahydrate (NiCl₂•6H2O) | 240 | g/L |
| Hydrochloric acid (HCl) | 85 | mL/L |
| Anodic activation time | 2 | minutes |
| Anodic activation current density | 22 | mA/cm² |
| Ni strike plating time | 6 | minutes |
| Ni strike plating current density | 22 | mA/cm² |

| | |
|---|---|
| Counter electxode | Ni |
| Agitation | Mild and mechanical |

The Haynes 230® coupons were then electrodeposited for 8 minutes in a Ni—Co/GDC bath, and optionally for 2 minutes in a separate pure Ni bath. The composition and current density of the Ni electrodeposition was identical to those of the Ni—Co/GDC, except that there was no Co or GDC present.

The purpose of the final Ni layer (shown in FIG. 1a) was to achieve a uniform surface free of adsorbed GDC particles.

To characterize the oxide scale, coated and uncoated specimens were oxidized in air at 1000° C. The samples oxidized for 170, 500 and 1000 hrs were characterized by means of a scanning electron microscope (SEM) equipped with an energy dispersive spectrometer (EDS). For this purpose, cross-sectional and plan view imaging along with EDS chemical analysis were performed. Cold mounting with epoxy resin followed by conventional grinding and polishing was used to prepare samples for cross-sectional analysis. Before mounting, specimens were gold coated with a sputter coater and electrodeposited with a layer of Ni to protect the oxide scale from being damaged during the polishing. Phase identification for oxide scale was performed via a glancing angle X-ray diffraction (XRD) technique. To avoid interference from the substrate, the incident X-ray beam angle was kept constant at 10° and a detector was scanned from 20 to 90°.

To analyze the kinetics of oxidation, coated and uncoated coupons were weighed periodically to obtain weight gain profiles as a function of time. The samples were air-cooled from furnace temperature for each weight gain test.

To measure the area specific resistance (ASR) of the coated and uncoated specimens, two samples were spot welded to Pt wires and pre-oxidized for 24 hours. Pre-oxidized coupons were placed face to face with a layer of Pt ink applied between them. To ensure a good contact between the samples, a spring load of 5 N was applied to the test coupons. Schematic representation of the experimental set-up used to measure the ASR is shown in FIG. 2. A constant current of 300 mA was applied for 5 minutes to the current Pt leads and the voltage was measured to obtain the resistance. The procedure was repeated every 10 hours. The following equation was used to calculate the ASR from applied current and measured voltage:

$$ASR = R \cdot A = \frac{V}{21} \cdot A ( Ω {cm}^{2} )$$

where R is the resistance (Ω), A is the surface area of the contact through which the current passes (cm²), V is voltage (V) and I is current (A). Since the current passes through two oxide scales, the ASR is divided by 2. The resistance contribution from the metallic substrate is neglected due much higher conductivity of metals over metal oxides.

To analyse Cr diffusion into the cathode materials, coated and uncoated samples were pre-oxidized in air at 1000° C. for 24 hours and subsequently screen printed with a ˜30 μm cathode paste. The cathode paste contained lanthanum strontium manganite (LSM) which is a standard cathode material and an organic binder. The screen printed coupons were further oxidized in air at 1000° C. for 170 hours. Cross sections of these specimens were analysed by SEM/FOX.

### Results and Discussion

### As Deposited Coating

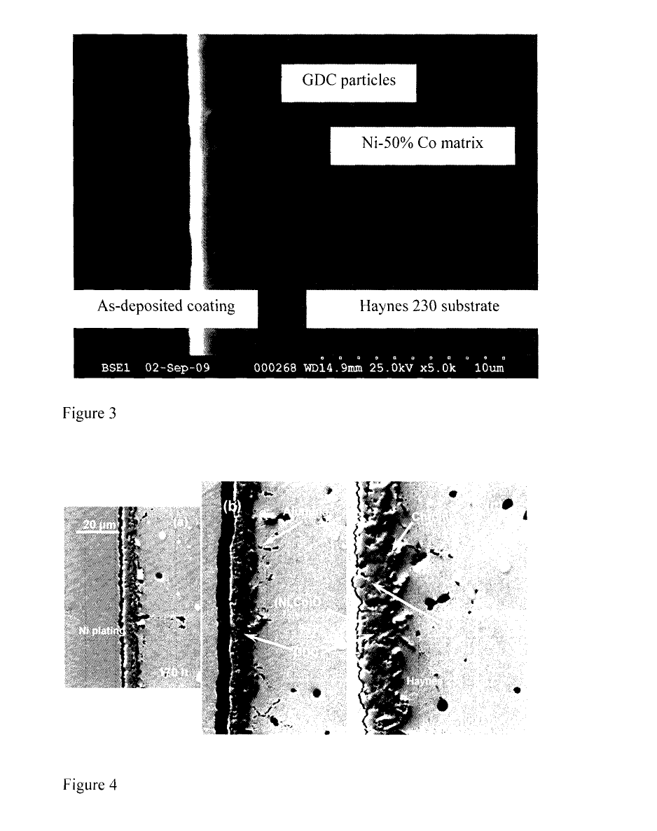

FIG. 3 shows the cross section image of the as deposited coating. A uniform distribution of GDC particles in observed in the alloy matrix of the coating layer. FOX analysis showed the matrix alloy is Ni with 50±2 wt % Co. The coating is uniform in thickness and a defect free interface between the coating and Haynes® 230® substrate is observed.

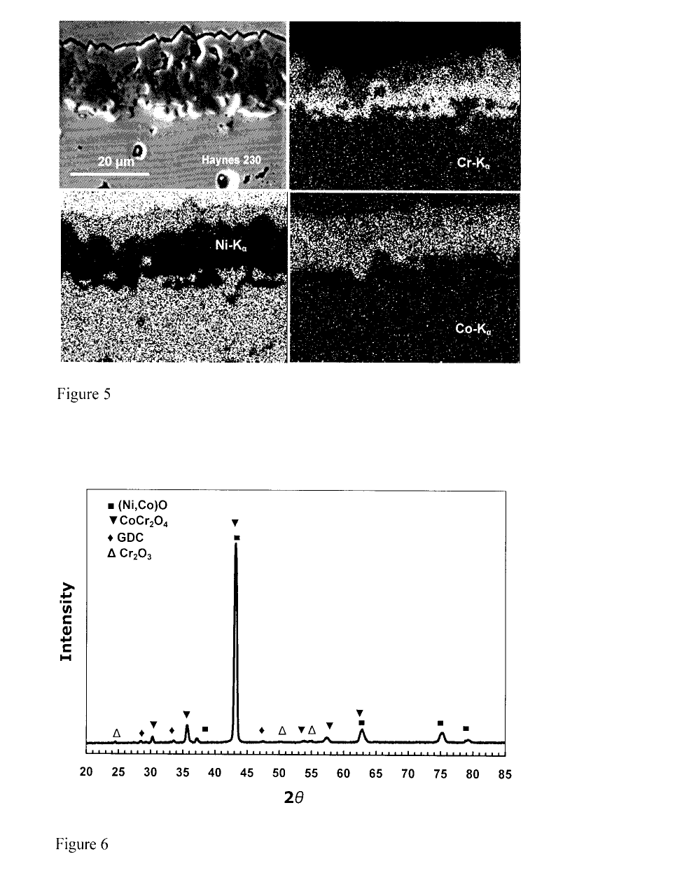

FIG. 4 shows the cross sectional images of the coated Haynes® 230® coupons oxidized for 170, 500 and 1000 hours. The SEM image of a coated Haynes® 230® oxidized for 1000 hours at 1000° C. along with EDX elemental maps for Cr, Ni and Co is presented in FIG. 5. The glancing angle XRD pattern for this specimen is shown in FIG. 6. The oxide scale comprises 3 layers (more visible in FIG. 5). The inner layer is rich in Cr and is identified as chromia. The midlayer is a cubic spinel solid solution containing mostly Co and Cr ions with small amounts of Ni and Mn (diffused from the substrate alloy). The peaks for spinel in XRD pattern match well with the CoCr₂O₄ spinel (JPDS file: 35-1321). The outer layer is a Cr-free solid solution of NiO and CoO. GDC particles are mostly located in the spinel midlayer, appearing as small white particles in FIG. 4. Internal oxidation of Al is also observed in FIG. 4. The bright regions in FIG. 4 are W-rich areas.

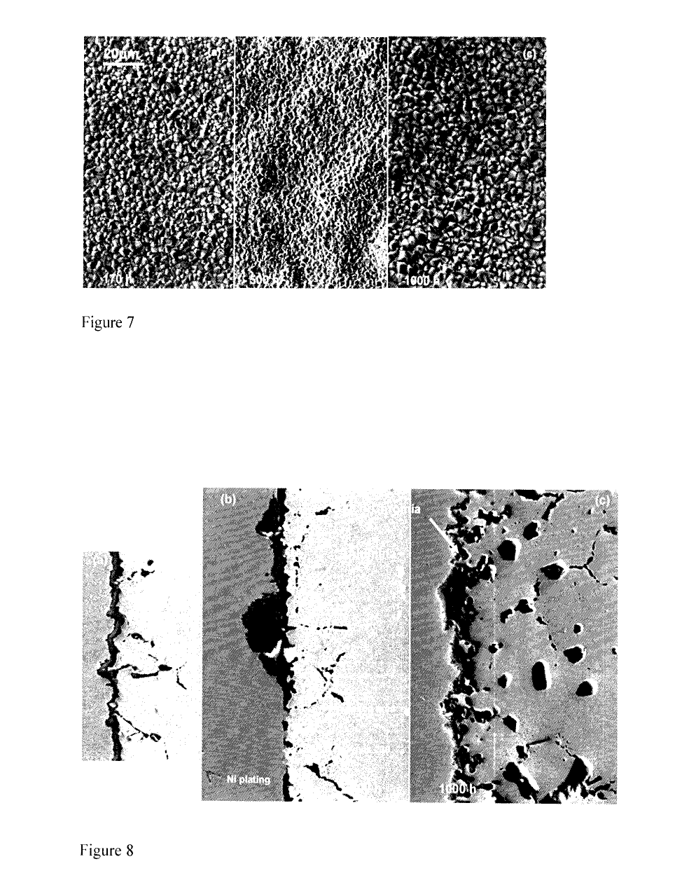

FIG. 7 shows the SEM plan view images from the surface of coated Haynes® 230° oxidized for 170, 500 and 1000 hours at 1000° C. in air. A uniform, even surface consisting of (Ni, Co)O crystallites is observed for these specimens, and oxide grains do not show a significant growth over the oxidation time.

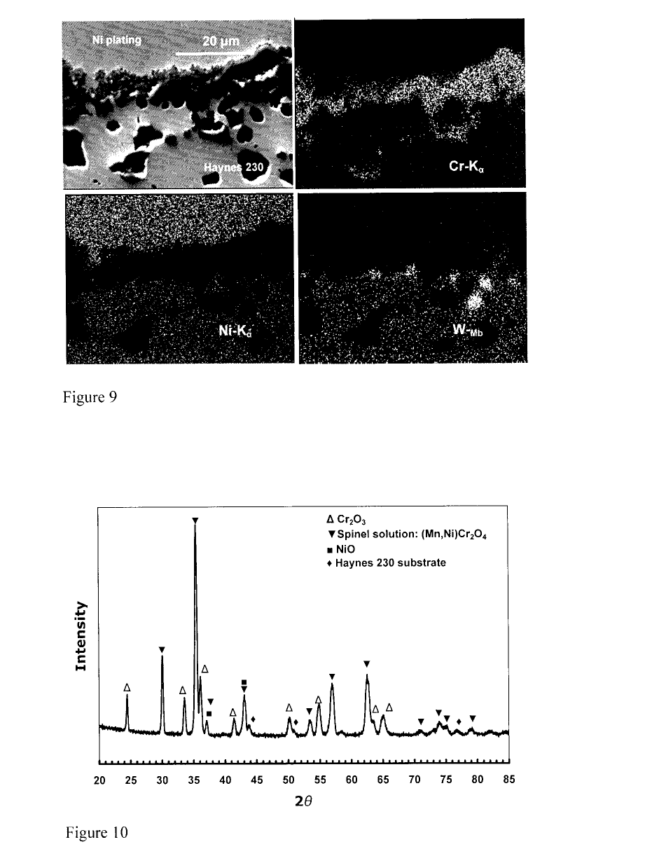

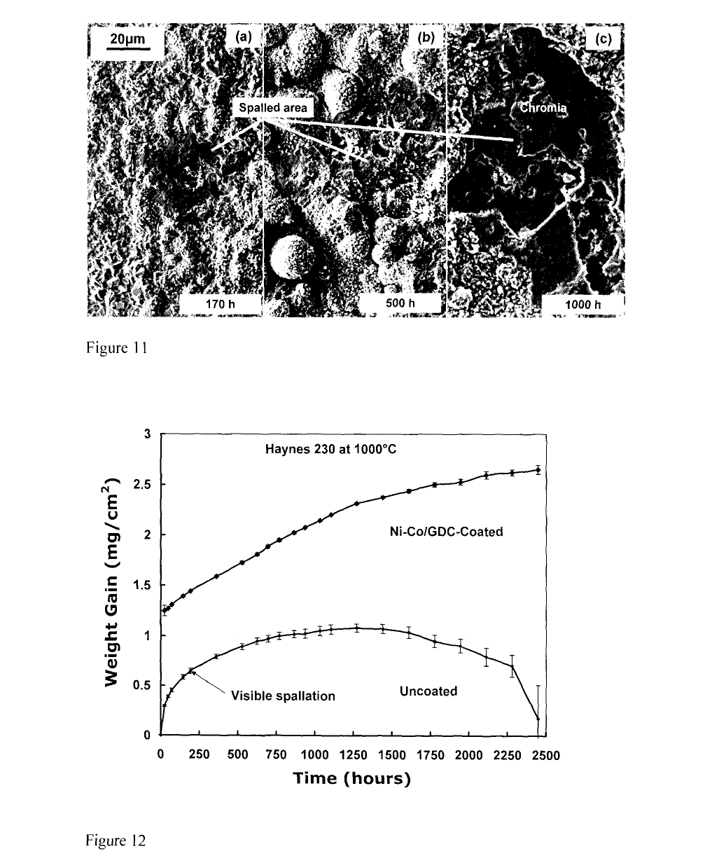

More specifically, FIG. 8 shows the SEM cross sectional images of uncoated Haynes® 230® oxidized at 1000° C. in air for 170, 500 and 1000 hours. FIG. 9 depicts the SEM image and corresponding EDX elemental maps for Cr, Ni and W for an uncoated Haynes® 230® oxidized for 1000 hours at 1000° C. The map for Mn is not shown in the figure due to very weak Mn X-ray signal implying very small level of Mn in the oxide layer. The glancing angle XRD pattern for this sample is also presented in FIG. 10. The oxide scale comprises an inner chromia layer covered with a thin spinel layer of MnCr₂O₄ containing trace levels of Ni. Spallation of the oxide scale is clearly observed in FIG. 8b. Severe internal oxidation and void formation is also seen for the sample oxidized for 1000 hours (FIG. 8c). The chromia layer for this sample appears thinner than those for the coupons oxidized for shorter times (FIGS. 8a and 8b). This may be due to severe Cr evaporation from the unprotected chromia scale. Spallation of the oxide scale is more visible in plain view images of oxidized uncoated Haynes® 230° shown in FIG. 11. The spallation occurs at the chromia-spinel interface exposing the volatile chromia layer. High Cr evaporation rates are expected from the exposed chromia layer. This indicates that uncoated Haynes® 230® cannot be used as SOFC interconnect material. The oxidation kinetics for coated and uncoated Haynes® 230® specimens is shown in FIG. 12. The initial higher weight gain for coated alloy is due to rapid oxidation of the metallic coating. A parabolic oxidation behavior is observed for the coated specimens after the initial oxidation. However, for the uncoated specimens such a parabolic kinetic behavior is not seen and, instead, a decrease in weight gain is observed. This is due to spallation and evaporation of the oxide scale which compensates for the oxidation weight gain.

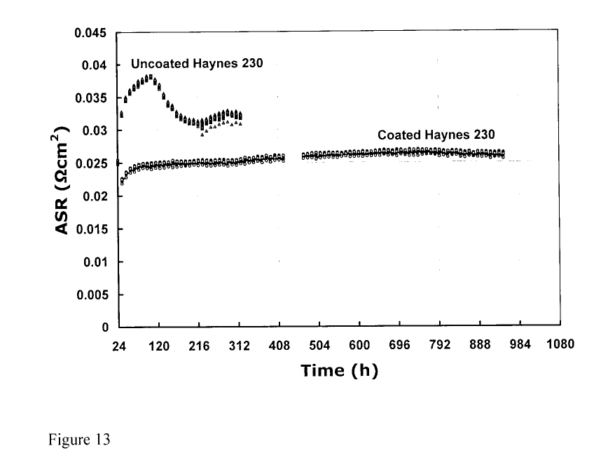

The ASR values for coated and uncoated coupons measured in air at 1000° C. are shown as function of time in FIG. 13. The coated samples show a very low, stable ASR of 26 mΩcm² while fluctuation is seen for the uncoated Haynes® 230®. This may be attributed to the uneven, nodular oxide surface morphology of the uncoated Haynes® 230® which results in changes in the actual surface area of contact and thus ASR. The decrease in ASR for uncoated coupons is attributed to thinning of the oxide scale due to evaporations and spallation.

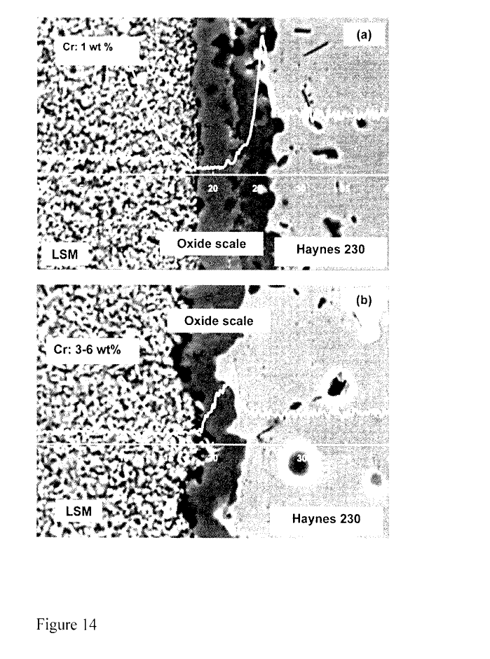

The amount of Cr diffused in the LSM layer in 170 hours for coated and uncoated Haynes® 234® coupons covered with a layer of screen printed LSM was determined by EDX. The amount of Cr diffused into the LSM overlaying layer is up to 1 wt % (the lower limit of detection by EDX) for the coated specimen while Cr diffused into the LSM from the uncoated sample ranges between 3-6 wt %. For both samples a uniform distribution of Cr is observed throughout the LSM layer. As seen in FIG. 14a from the Cr concentration profile, the (Ni, Co)O outer oxide scale layer retains negligible amount of Cr and may act as Cr diffusion barrier separating the CoCr₂O₄ layer from the cathode. Therefore, thicker coatings may be more effective to reduce Cr outward diffusion.

### Example 2

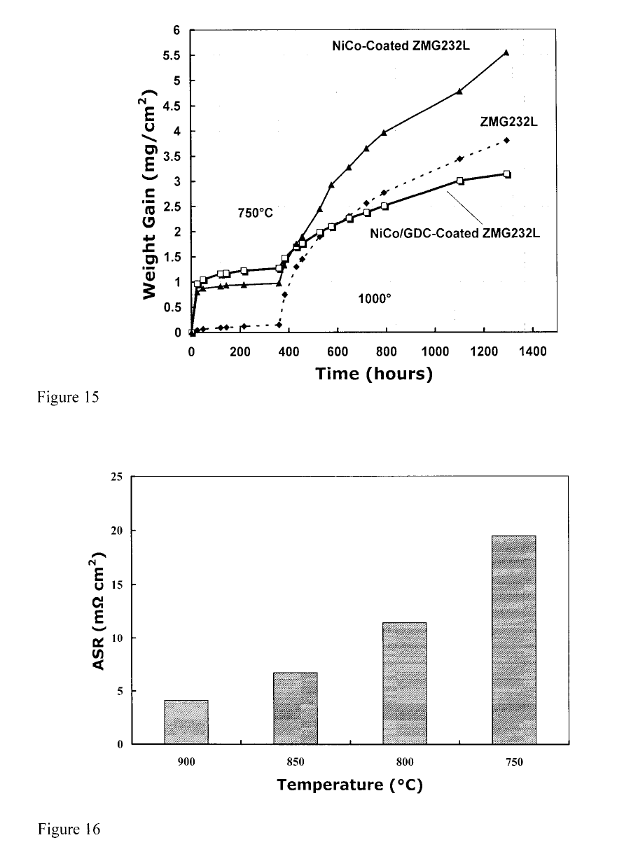

The procedure described in Example 1 was used to coat ZMG232L, ferritic stainless steel (Hitachi product). The coating composition is also the same as in Example 1. The composition for ZMG232L is listed in Table IV. The measurement and characterization techniques were identical to Example 1. The oxidation weight gain profiles in FIG. 15 show significant reduction in oxidation weight gain for NiCo/GDC composited coated specimens. The oxidation weight gain for coated specimens without GDC particles is much higher than even uncoated substrate. This indicates that rare earth metal oxide particles are indispensible constituent of the coating.

As seen in FIG. 16, the ASR values at different temperatures for NiCo/GDC (50% Co) coated ZMG232L® are well below the generally accepted criteria for SOFC interconnects that is 100 mΩcm2.

TABLE IV
nominal composition (wt. %) of ZMG232L ® ferritic
stainless steel

| Fe | Cr | C | Si | Mn | Ni | Al | Zr | La |
|---|---|---|---|---|---|---|---|---|
| Bal. | 22 | 0.02 | 0.08 | 0.46 | 0.34 | 0.05 | 0.19 | 0.05 |

### Example 3

Interconnect plates of Crofer® 22H (see Table V for composition) were coated using the same coating composition and technique described in Example 1. Short stack cell testing was performed for 800 hours at 700° C. and is intended to be continued for several thousand hours. The coated interconnect plates showed 0.1-0.2%/1000 hours less degradation than uncoated plates. However, longer times are required to observe the full benefits of the coating since chromium poisoning effect requires several thousand of hours to appear.

TABLE V
nominal composition (wt %) of Crofer 22 H ® ferritic stainless steel

| Fe | Cr | C | N | S | Si | Mn | Al | W | Ti | La | P | Cu |
|---|---|---|---|---|---|---|---|---|---|---|---|---|
| Bal. | 20-24 | 0.03 max | 0.03 max | 0.006 max | 0.1-0.6 | 0.3-0.8 | 0.1 max | 1-3 | 0.02-0.2 | 0.04-0.2 | 0.05 max | 0.5 max |

### CONCLUSIONS

The composite coating material according to the present invention meets the criteria for interconnect application. In Examples 1 and 2, the oxidized Ni—Co/GDC coating on a Haynes® 230® and ZMG232L® substrates provides a unique oxide scale tri-layer structure, comprising an inner chromia (containing GDC particles) layer, an intermediate CoCr2O4 spinel (containing GDC particles) layer, and an outer (Ni, Co)O solid solution layer. This oxide scale structure offers the following advantages over the uncoated substrate:
Substantially complete elimination of oxide scale spallation
Smooth and even oxide surface which ensures a reliable contact with cathode material to more efficiently collect current
Reduction of oxidation and internal damage to the substrate
Reduction and stabilization of ASR
Reduction of Cr outward diffusion.

The coating technique according to the present invention, comprising composite electrodeposition, offers the following unique advantages over other coating techniques:
Simplicity of the process
Low cost
Practicality of coatings on complex configurations
Easy control over composition, particle type and content and thickness of the coating.

### REFERENCES

[1] A. Petric, H. Ling, Journal of the American Ceramic Society, 90 (2007) 1515-1520.
[2] N. Shaigan, D. G. Ivey, W. X. Chen, Journal of Power Sources, 183 (2008) 651-659.
[3] N. Shaigan, D. G. Ivey, W. X. Chen, Journal of Power Sources, 185 (2008) 331-337.
[4] M. R. Bateni, P. Wei, X. H. Deng, A. Petrie, Surface & Coatings Technology, 201 (2007) 4677-4684.
[5] X. H. Deng, P. Wei, M. R. Bateni, A. Petrie, Journal of Power Sources, 160 (2006) 1225-1229.
[6] P. Wei, X. Deng, M. R. Bateni, A. Petrie, Corrosion, 63 (2007) 529-536.
[7] Z. G. Yang, G. G. Xia, J. W. Stevenson, Electrochemical and Solid State Letters, 8 (2005) A168-A170.
[8] Z. G. Yang, G. G. Xia, X. H. Li, J. W. Stevenson, International Journal of Hydrogen Energy, 32 (2007) 3648-3654.
[9] U.S. Pat. No. 5,942,349

1. An oxidized metal matrix composite coated substrate, comprising a substrate made of a material selected from the group consisting of a chromia-forming Fe, Ni and/or Co based alloy containing an amount of Cr ranging from 16 to 30 wt %, and an oxide-dispersion strengthened Cr-based alloy and a plain Cr-based alloy, and an oxidized metal matrix composite coating comprising at least two metals and reactive element oxide particles in the form of a tri-layer scale on the substrate surface comprising an inner chromia layer, an intermediate layer of a spinel solid solution formed by Cr and one or more of the deposited metals selected from the group consisting of Ni, Co, Cu, Mn, Fe and Zn and a mixture thereof, and an electrically conductive top layer comprising oxides of one or more deposited metals selected from the group consisting of Ni, Co, Cu, Fe, Mn, Zn and a mixture thereof, which is substantially free from Cr ions, and wherein one or more of such layers contain particles of doped or undoped oxides of a rare earth metal selected from the group consisting of Ce, Y, La, Hf, Zr, Gd and a mixture thereof.

2. An oxidized metal matrix composite coated substrate according to claim 1, wherein the chromia-forming substrate is selected from Fe, Ni, and Co based alloys.

3. An oxidized metal matrix composite coated substrate according to claim 1, wherein the substrate is a chromia-forming alloy containing 20 to 28 wt % of Cr.

4. An oxidized metal matrix composite coated substrate according to claim 1, wherein the substrate is an oxide-dispersion strengthened Cr-based alloy comprising 94% Cr, 5% Fe and 1% Y₂O₃)

5. An oxidized metal matrix composite coated substrate according to claim 1, wherein the substrate is a Cr-based alloy comprising 95% Cr and 5% Fe.

6. An oxidized metal matrix composite coated substrate according to claim 1, wherein the substrate is a Ni-based alloy comprising 57 wt % Ni, 22 wt % Cr, 14 wt % W, 2 wt % Mo, 3 wt % Fe, 5 wt % Co, 0.5 wt % Mn, 0.4 wt % Si, 0.3 wt % Al, 0.1 wt % C. 0.02 wt % La and 0.015 wt % B.

7. An oxidized metal matrix composite coated substrate according to claim 1, wherein the substrate is a ferritic stainless steel alloy comprising 22 wt % Cr, 0.46 wt % Mn, 0.34 wt % Ni, 0.19 wt % Zr, 0.08 wt % Si, 0.05 wt % Al, 0.05 wt % La, 0.02 wt % C and balance to 100 wt % of Fe.

8. An oxidized metal matrix composite coated substrate according to claim 1, wherein the substrate is a ferritic stainless steel alloy comprising 20-24 wt % Cr, 1.0-3.0 wt % W, 0.3-0.8 wt % Mn, 0.1-0.6 wt % Si, maximum 0.1 wt % Al, 0.02-0.2 wt % Ti, 0.04-0.2 wt % La, maximum 0.03 wt % C, maximum 0.03 wt % N, maximum 0.006 wt % S, maximum 0.05 wt % P, maximum 0.5 wt % Cu and balance to 100 wt % of Fe.

9. An oxidized metal matrix composite coated substrate according to claim 1, wherein the intermediate spinel layer comprises CoCr₂O₄.

10. An oxidized metal matrix composite coated substrate according to claim 1, wherein the intermediate layer additionally comprises a metal element diffused from the substrate.

11. An oxidized metal matrix composite coated substrate according to claim 10, wherein the metal element is Mn, Fe or a mixture thereof.

12. An oxidized metal matrix composite coated substrate according to claim 1, wherein the rare earth metal particles are gadolinia doped ceria (GDC), dispersed in the coating in all three layers.

13. An oxidized metal matrix composite coated substrate according to claim 1, wherein the composite coating comprises an inner chromia (containing GDC particles) layer, an intermediate CoCr₂O₄ spinel (containing GDC particles) layer, and an outer (Ni, Co)O solid solution layer.

14. An oxidized metal matrix composite coated substrate according to claim 1, wherein the particle size of the rare earth metal oxide particles is from 0.05-50 μm, preferably 0.5-3 μm and more preferably 0.5-1 μm.

15. An oxidized metal matrix composite coated substrate according to claim 1 used in the form of an electrical interconnect device in an SOFC stack.

16. A method of making an oxidized metal matrix composite coated substrate, comprising
(a) providing an electrodeposition cell, including an anode, a chromia-forming cathode substrate and an aqueous electrolyte, wherein the said electrolyte comprises a source of a depositing metal selected from the group consisting of Ni, Co, Mn, Cu, Fe, Zn and a mixture thereof, and suspended particles of an insoluble doped or undoped oxide of a rare earth metal selected from the group consisting of Ce, Y, La, Hf, Zr, Gd and a mixture thereof,
(b) pre-treating the chromia-forming substrate to remove the native chromium oxide layer from the substrate surface,
(c) pre-treating of the substrate, substantially free from oxide, by applying a thin (˜1 μm) strike Ni or Co plating from a chloride based electrolyte containing hydrochloric acid to the substrate to prevent reformation of the native oxide,
(d) electrodepositing of a composite coating onto the pretreated (Ni- or Co-coated) chromia-forming substrate in the electrodeposition cell, wherein the cathode is the pretreated chromia-forming substrate, and wherein electrodepositing of the composite coating onto the substrate is performed by applying a direct or pulsating current to the electrodeposition cell, and
(e) oxidation in air of the coated substrate at elevated temperature, to form a unique composite tri-layer scale coating, comprising on the substrate surface an inner chromia layer, an intermediate spinel solid solution layer formed by Cr and one or more of the deposited metals selected from the group consisting of Ni, Co, Cu, Mn, Fe, Zn and a mixture thereof, and a top layer comprising an electrically conductive oxide layer of the deposited metals selected from the group consisting of Ni, Co, Cu, Mn, Fe, Zn and a mixture thereof, which is substantially free of Cr ions, wherein one or more of such layers contain particles of doped or undoped oxides of a rare earth metal selected from the group consisting of Ce, Y, La, Hf, Zr, Gd and a mixture thereof.

17. A method according to claim 16, wherein the source of depositing metals is selected from the group consisting of metal salts, including sulfates and/or chlorides and complexed metal ions, such as Ni sulfamates.

18. A method according to claim 16, wherein the electrolyte includes an optional additive selected from the group consisting of a buffering compound, surfactants, brighteners, levelers and a mixture thereof.

19. A method according to claim 16, wherein the buffering compound is boric acid.

20. A method according to claim 16, wherein the plating is conducted in an aqueous electrolyte containing Ni or Co sulfates and optionally chlorides and boric acid and rare earth oxide particles using Ni or Co anodes.

21. A method according to claim 16, wherein step (e), the elevated temperature is in the range of 500 to 1000° C. for at least 24 hours.

22. A method according to claim 16, wherein the chromia-forming substrate is a material selected from the group consisting of a chromia-forming Fe, Ni or Co based alloy containing an amount of Cr ranging from 16 to 30 wt %, and an oxide-dispersion strengthened Cr-based alloy and a plain Cr-based alloy.

23. A method according to claim 16, wherein the intermediate layer additionally comprises a metal element diffused from the substrate.

24. A method according to claim 23, wherein the metal element is Mn, Fe or a mixture thereof.

25. A method according to claim 16, wherein the composite coating comprises an inner chromia (containing GDC particles) layer, an intermediate CoCr₂O₄ spinel (containing GDC particles) layer, and an outer (Ni, Co)O solid solution layer.

26. A method according to claim 16, wherein step (b) the pre-treatment comprises the electrochemical and/or chemical etching of the substrate, wherein the said chemical etching is conducted in an aqueous solution of compounds selected from the group consisting of hydrochloric acid, nitric acid/hydrofluoric acid, ferric chloride and ceric ammonium nitrate.
